(19) United States
(12) Patent Application Publication
(10) Pub. No.: US 2026/0121243 A1
(43) Pub. Date: Apr. 30, 2026

(54) Method for Manufacturing Battery Module Including Weld Bead

(71) Applicant: SK On Co., Ltd., Seoul (KR)

(72) Inventors: Sung Chel YOON, Daejeon (KR); Kyung Min LEE, Daejeon (KR); Jae Hun KIM, Daejeon (KR); Taehyun KIM, Daejeon (KR); Ji Hun KIM, Daejeon (KR)

(21) Appl. No.: 19/367,958

(22) Filed: Oct. 24, 2025

(30) Foreign Application Priority Data
Oct. 28, 2024 (KR) 10-2024-0148251

(51) Int. Cl. H01M 50/516; B23K 26/06; B23K 26/26; B23K 26/28; H01M 50/505; H01M 50/522; H01M 50/534

(52) U.S. Cl. CPC H01M 50/516; B23K 26/0626; B23K 26/26; B23K 26/28; H01M 50/505; H01M 50/522; H01M 50/534

(57) ABSTRACT

Provided is a method for manufacturing a battery module including a weld bead. An embodiment of the present disclosure is directed to providing a method for manufacturing a battery module including a weld bead, in which a laser having a relatively higher irradiation intensity or a higher laser irradiation path density is applied to a region where a relatively smaller heat input is formed under laser irradiation of the same intensity, that is, a region irradiated while a laser focus is not matched, thereby ultimately forming a equivalent left-right heat input during laser irradiation to resolve a left-right imbalance occurring in a welded portion caused by an inclined laser irradiation direction during laser welding.

### CROSS-REFERENCE TO RELATED APPLICATIONS

This application claims priority under 35 U.S.C. § 119 to Korean Patent Application No. 10-2024-0148251, filed on Oct. 28, 2024, in the Korean Intellectual Property Office, the disclosure of which is incorporated herein by reference in its entirety.

### TECHNICAL FIELD

The following disclosure relates to a method for manufacturing a battery module including a weld bead, and more particularly, to a method for manufacturing a battery module having improved mechanical properties by improving a laser welding method to resolve a left-right imbalance occurring in a welded portion caused by an inclined laser irradiation direction during laser welding.

### BACKGROUND

Recently, demand specifications for high-capacity and high-output secondary batteries have been increasing, and it has become necessary to develop secondary batteries requiring high energy density, high performance, and a high level of reliability corresponding to such demand specifications. In manufacturing a secondary battery, when configuring positive and negative electrodes, joining of the positive and negative electrodes is required to electrically connect battery cells, and a dissimilar joining method using aluminum and copper members is generally widely used. Aluminum members and copper members are both widely used in electronic and electric components, heat dissipation components, or the like due to their excellent electrical and thermal conductivity, and are also utilized as components of secondary batteries. Here, in consideration of product miniaturization, weight reduction, and assembly convenience, a joint structure in which copper members and aluminum members are joined to each other is required, and thus dissimilar joining is frequently necessary also in manufacturing secondary batteries. In particular, in an electrical connection method between battery cells requiring a high level of reliability, various techniques such as ultrasonic welding, laser welding, and mechanical fastening (bolt/nut) are used, and, in order to cope with the gradually increasing energy density requirements, laser welding is currently used as the most common joining method.

FIG. 1 illustrates a secondary battery module including a weld bead and a cross-section of a welded portion according to an embodiment. In the secondary battery module illustrated in FIG. 1, an electrode lead 110 disposed in each battery cell 100 and a bus bar 120 that electrically connects the electrode leads 110 to each other are illustrated as being joined by a weld bead 150. The weld bead 150 may be formed by melting the electrode leads 110 and the bus bars 120 through laser irradiation and then solidifying while being mixed with each other. A cross-sectional view taken along line P-P′ in an upper perspective view of FIG. 1 is illustrated in a lower part of FIG. 1, and from this view, it may be intuitively understood to what extent the electrode leads 110 and the bus bars 120 are firmly joined to each other by the weld bead 150.

A laser welding process may be briefly described as follows. When laser irradiation is applied to members to be joined while the members are disposed in proximity and high thermal energy is thereby applied, the members disposed in proximity may be partially melted by thermal energy and mixed with each other. When the laser irradiation to a corresponding portion is stopped in this state, the melted portions of the members may be partially solidified in the state as they are while being mixed and combined with each other, thereby achieving a firm joining. The laser irradiation may be performed in a straight line along the joining portion. However, in order to achieve a firmer joining, it is preferable that melting and mixing occur in a greater area. That is, it is preferable to form a laser irradiation path to enable irradiated regions to overlap multiple times centered on the joining portion. Korean Patent No. 1116638 (“Laser Welding Method of Steel Sheet”, Feb. 8, 2012) discloses technical contents of improving welding quality and joining strength by forming a laser irradiation path in a zigzag shape during laser welding. FIG. 2 illustrates a side view of a laser irradiation direction and a top view of the laser irradiation path during laser welding, and effectively illustrates an example in which the laser irradiation path is formed in a zigzag shape centered on the joining portion.

However, even the laser welding has several factors that degrade the welding quality, which may be described as follows.

Assuming that laser irradiation is applied perpendicularly to the joining portion, it is apparent that the laser irradiation path formed in a zigzag shape centered on the joining portion is optimal. However, in an actual manufacturing environment, the laser irradiation direction is not frequently formed perpendicular to the joining portion. That is, as illustratively shown in FIG. 2, the laser irradiation direction may be formed to be inclined with respect to the joining portion. FIG. 3 is a diagram illustrating a heat input imbalance caused by the laser irradiation direction. As illustrated in FIG. 3, when the laser irradiation direction is inclined, if a laser focus is aligned on one side (left or right side) relative to the joining portion (i.e., a “laser in-focus” side in FIG. 3), the other side may be inevitably unfocused (i.e., a “laser out-focus” side in FIG. 3), resulting in a difference in heat input. That is, the laser in-focus side may receive a designed heat input sufficiently applied thereto, and an expected melting amount may thus be produced, whereas the “laser out-focus” side may receive insufficient heat input, and less melting amount than expected may thus be produced. Even if such a left-right imbalance occurs, simply joining two members may not cause a significant problem. However, in joining three members, such as the electrode lead-bus bar connection illustrated in FIG. 1, this left-right imbalance may have a considerable adverse effect on product durability.

FIG. 4 illustrates a comparison between an ideal weld bead and an actual weld bead. If the ideal welding is performed as designed, the weld bead may be formed in a symmetrical shape as illustrated in an upper part of FIG. 4. However, as described above, due to the left-right imbalance occurring in the heat input, the weld bead may actually be formed in an asymmetrical shape having the left-right imbalance as illustrated in a lower part of FIG. 4.

The left-right imbalance may occur not only in terms of shape but also in terms of material properties. In performing laser welding of dissimilar materials, intermetallic compounds (IMC) may be generated, and the intermetallic compounds (IMC) have physical properties of high electrical resistance and high hardness, thus adversely affecting mechanical properties of the welded portion such as brittleness, and possibly adversely affecting battery characteristics due to an increase in resistance in electrical connection between battery cells. In this case, depending on a difference in heat input between the left and right sides, a left-right imbalance in terms of material properties may occur in which the IMC is biased to be generated more on one side, thereby causing a difference in rigidity between the left and right sides and adversely affecting the product durability.

### SUMMARY

An embodiment of the present disclosure is directed to providing a method for manufacturing a battery module including a weld bead, in which a laser having a relatively higher irradiation intensity or a higher laser irradiation path density is applied to a region where a relatively smaller heat input is formed under laser irradiation of the same intensity, that is, a region irradiated while a laser focus is not matched, thereby ultimately forming a equivalent left-right heat input during laser irradiation to resolve a left-right imbalance occurring in a welded portion caused by an inclined laser irradiation direction during laser welding.

In one general aspect, provided is a method for manufacturing a battery module including a weld bead, in which the battery module includes a plurality of battery cells 100 stacked on each other and each including electrode leads 110, a bus bar 120 including a plurality of fitting parts into which the electrode leads protruding from the battery cells 100 are inserted, and a weld bead 150 formed by laser welding to couple the electrode leads 110 to the bus bars 120, wherein when a direction in which the electrode lead 110 protrudes and extends from the battery cell 100 is referred to as an extension direction, a direction in which the battery cells 100 are stacked is referred to as a stacking direction, and a direction perpendicular to the extension direction or the stacking direction and in which welding is performed is referred to as a welding direction, the method including: a temporary coupling step of temporarily coupling the electrode lead 110 to the fitting part by being inserted therein; and a welding coupling step of welding and coupling a coupled portion between the electrode lead 110 and the bus bar 120 by irradiating the temporarily coupled portion with a laser in a direction inclined with respect to the extension direction or the stacking direction, based on a central position of the electrode lead 110 in the stacking direction, while forming a laser irradiation path in a periodic function pattern having a predetermined amplitude and predetermined period with respect to a central line of the electrode lead 110 in the stacking direction, wherein a laser heat input in the in-focus region and a laser heat input in the out-focus region are adjusted to be equivalent when one of left and right sides relative to the central line of the electrode lead in the stacking direction corresponds to an in-focus region and the other corresponds to an out-focus region as the laser irradiation direction is inclined.

A laser irradiation intensity is varied or a laser irradiation path density is varied in order to make the laser heat input in the in-focus region is equivalent to the laser heat input in the out-focus region, when the laser irradiation intensity is varied, the laser irradiation intensity may be varied to allow the laser irradiation intensity at a laser irradiation position in the out-focus region to be greater than the laser irradiation intensity at a laser irradiation position in the in-focus region, and when the laser irradiation path density is varied, the laser irradiation path pattern may be formed to have the laser irradiation path density varied to allow the laser irradiation path density at the laser irradiation position in the out-focus region to be greater than the laser irradiation path density at the laser irradiation position in the in-focus region.

As a first embodiment, the laser irradiation intensity may be varied to make the laser heat input in the in-focus region and the laser heat input in the out-focus region equivalent, the laser irradiation intensity being formed to have the periodic function pattern having the same period as the laser irradiation path to correspond to a variation in the laser irradiation position along the laser irradiation path.

The laser irradiation path may be formed to have a zigzag pattern, and the laser irradiation intensity may be formed to have a pulse pattern in which the laser irradiation intensity is set to have a first constant value when the laser irradiation position is in the in-focus region and a second constant value when the laser irradiation position is in the out-focus region, the first constant value being smaller than the second constant value.

The laser irradiation path may be formed to have a wave function pattern, and the laser irradiation intensity may be formed to have the wave function pattern in which a maximum value of the laser irradiation intensity in the in-focus region is set to have a first constant value, and a minimum value of the laser irradiation intensity in the out-focus region is set to have a second constant value, the first constant value being smaller than the second constant value.

As a second embodiment, the laser irradiation path density may be varied to make the laser heat input in the in-focus region and the laser heat input in the out-focus region equivalent.

The laser irradiation path may be formed in a zigzag pattern, in which a pattern central line may be biased to the out-focus region.

The laser irradiation path may be formed in an M-shaped pattern if the M-shaped pattern is defined as a pattern formed within a range of a pair of pattern boundary lines extending parallel to each other, and including an M-shaped first path and an M-shaped second path, which are alternately disposed, when a pattern central line extends in parallel to the pair of pattern boundary lines at a central position of the pair of pattern boundary lines, the M-shaped first path proceeding in a straight line in an order of one pattern boundary line, the other pattern boundary line, and the one pattern boundary line, the M-shaped second path proceeding in a straight line in an order of the one pattern boundary line, the pattern central line, and the one pattern boundary line, the M-shaped second path being disposed in the out-focus region, and the pattern central line being disposed to coincide with the central line of the electrode lead 110 in the stacking direction.

The laser irradiation path may be formed in a figure-8 pattern, the figure-8 pattern being a pattern including a figure-8 first path and a figure-8 second path, which are alternately disposed, as a pattern formed within a range of a pair of pattern boundary lines extending in parallel to each other when a pattern reference line at an arbitrary position within the range of the pair of pattern boundary lines extends in parallel to the pair of pattern boundary lines, the figure-8 first path proceeding in an elliptical shape in an order of the pattern reference line, one pattern boundary line, and the pattern reference line, the figure-8 second path proceeding in an elliptical shape in an order of the pattern reference line, the other pattern boundary line, and the pattern reference line, and the figure-8 first path being disposed in the out-focus region, and the pattern reference line being disposed to coincide with the central line of the electrode lead in the stacking direction when the pattern reference line is biased to the other side to have a major axis of an ellipse formed by the figure-8 first path is greater than a major axis of an ellipse formed by the figure-8 second path.

A laser heat input value may be in a range of 30 J/mm² to 43 J/mm².

In another general aspect, provided is a battery module including: a plurality of battery cells 100 stacked on each other and each including electrode leads 110; a bus bar 120 including a plurality of fitting parts into which the electrode leads 110 protruding from the battery cells 100 are inserted; and a weld bead 150 formed by laser welding to couple the electrode leads 110 to the bus bars 120, wherein, when a direction in which the battery cells 100 are stacked is referred to as a stacking direction, and left and right sides are determined based on a central line of the electrode lead 110 in the stacking direction, the weld bead 150 has a shape satisfying the following expression:

$$\vert w 1 - w 2 \vert < 0.1 mm$$

(where w1 refers to a distance from a left outer surface of the electrode lead 110 to a left end of the weld bead 150, and w2 refers to a distance from a right outer surface of the electrode lead 110 to a right end of the weld bead 150).

The weld bead 150 may have a shape satisfying the following expressions:

$$0.5 mm < w 1 < 0.8 mm , and 0.5 mm < w 2 < 0.8 mm .$$

The weld bead 150 may have a shape satisfying the following expressions:

$$120 \% < w 1 / ( w - w 1 - w 2 ) < 200 \% , and 120 \% < w 2 / ( w - w 1 - w 2 ) < 200 \%$$

(where w refers to a distance from the left end of the weld bead 150 to the right end of the weld bead 150).

The electrode lead 110 may include an aluminum material, and the bus bar 120 may include a copper material.

The weld bead 150 may have a copper weight ratio value in a range of 5 wt % to 50 wt %.

Other features and aspects will be apparent from the following detailed description, the drawings, and the claims.

### BRIEF DESCRIPTION OF THE DRAWINGS

FIG. 1 illustrates a secondary battery module including a weld bead and a cross-section of a welded portion according to an embodiment.

FIG. 2 illustrates a side view of a laser irradiation direction and a top view of a laser irradiation path during laser welding.

FIG. 3 illustrates a heat input imbalance caused by the laser irradiation direction.

FIG. 4 illustrates a comparison between an ideal weld bead and an actual weld bead.

FIG. 5 illustrates a laser irradiation intensity variation pattern according to a first embodiment.

FIG. 6 illustrates a comparison between a laser irradiation intensity according to a prior art and a laser irradiation intensity according to the first embodiment.

FIG. 7 illustrates a principle for resolving a left-right imbalance based on the laser irradiation intensity variation according to the first embodiment.

FIG. 8 illustrates a laser irradiation path pattern according to a second embodiment (i.e., Embodiment 2-1).

FIG. 9 illustrates a laser irradiation path pattern according to a second embodiment (i.e., Embodiment 2-2).

FIG. 10 illustrates a laser irradiation path pattern according to a second embodiment (i.e., Embodiment 2-3).

FIG. 11 illustrates a comparison between a weld bead shape according to the prior art and a weld bead shape according to the present disclosure.

### DETAILED DESCRIPTION OF EMBODIMENTS

Hereinafter, a method for manufacturing a battery module including a weld bead that has the above-described configuration according to the present disclosure are described in detail with reference to the accompanying drawings.

### [1] Concept of the Method for Manufacturing a Battery Module According to the Present Disclosure

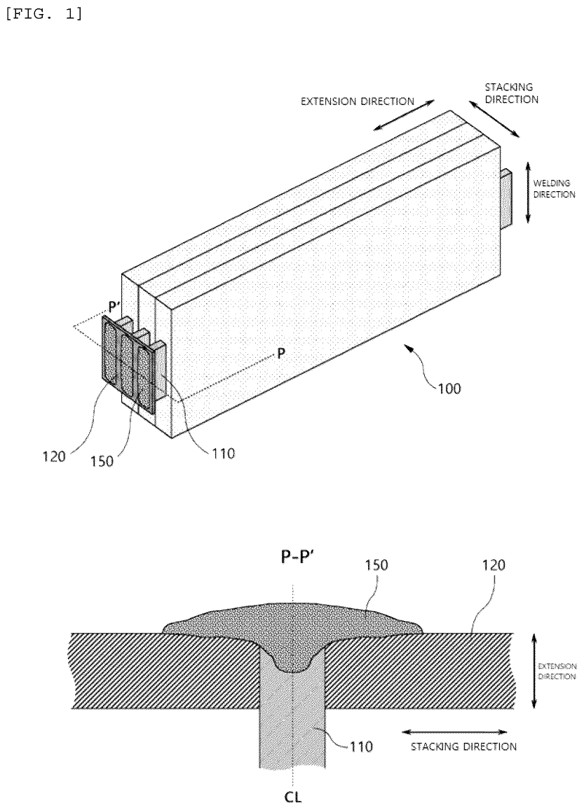

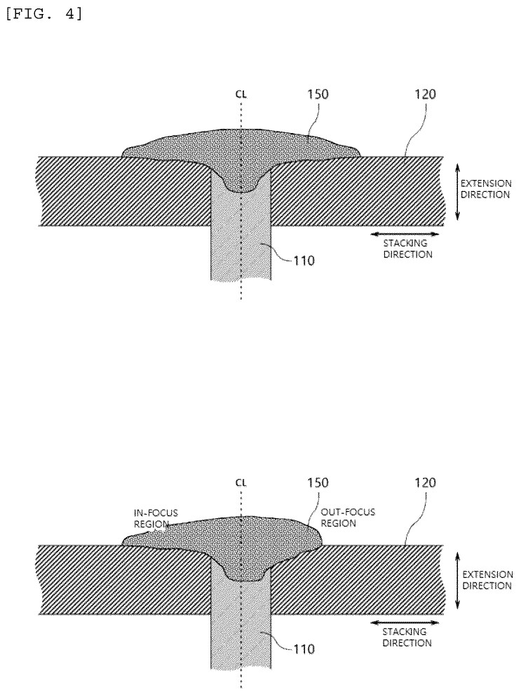

The method for manufacturing a battery module according to the present disclosure is basically a method for manufacturing a battery module as illustrated in FIG. 1. To describe a configuration of the battery module in more detail, the battery module may include: a plurality of battery cells 100 stacked on each other and each including electrode leads 110; a bus bar 120 including a plurality of fitting parts into which the electrode leads 110 protruding from the battery cells 100 are inserted; and a weld bead 150 formed by laser welding to couple the electrode leads 110 to the bus bars 120. Here, as illustrated in FIGS. 1 to 4, a direction in which the electrode lead 110 protrudes and extends from the battery cells 100 is referred to as an extension direction, a direction in which the battery cells 100 are stacked is referred to as a stacking direction, and a direction perpendicular to the extension direction or the stacking direction and in which welding is performed is referred to as a welding direction.

The present disclosure mainly focuses on welding coupling between the electrode leads 110 and the bus bars 120. Therefore, processes other than a process for coupling the electrode leads 110 to the bus bars 120 are regarded as following a general method for manufacturing a battery module, and descriptions thereof are omitted here. The welding coupling between the electrode leads 110 and the bus bars 120 may briefly include a temporary coupling step and a welding coupling step. As the term indicates, the temporary coupling step refers to a preparatory step in which the electrode leads 110 are temporarily coupled to the fitting parts by being fitted therein before an actual operation. The actual welding coupling may be performed in the welding coupling step, and a more detailed description thereof is provided as follows.

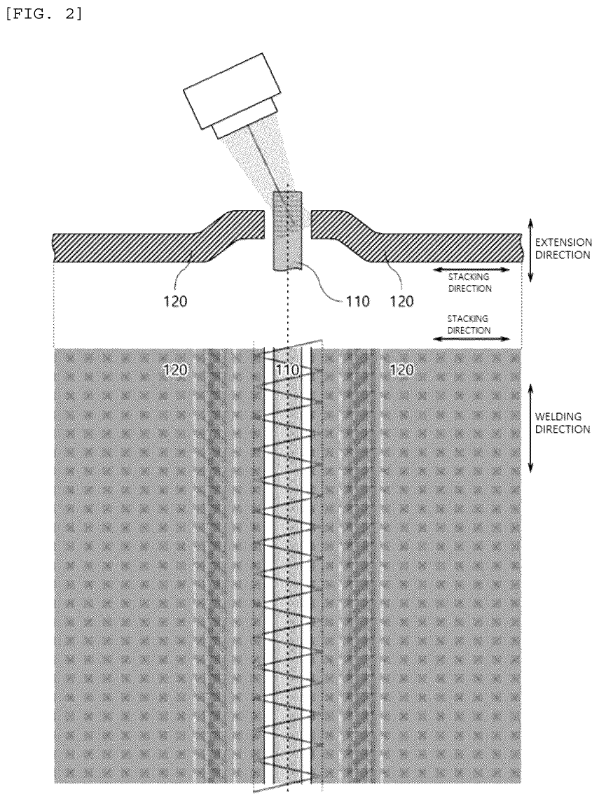

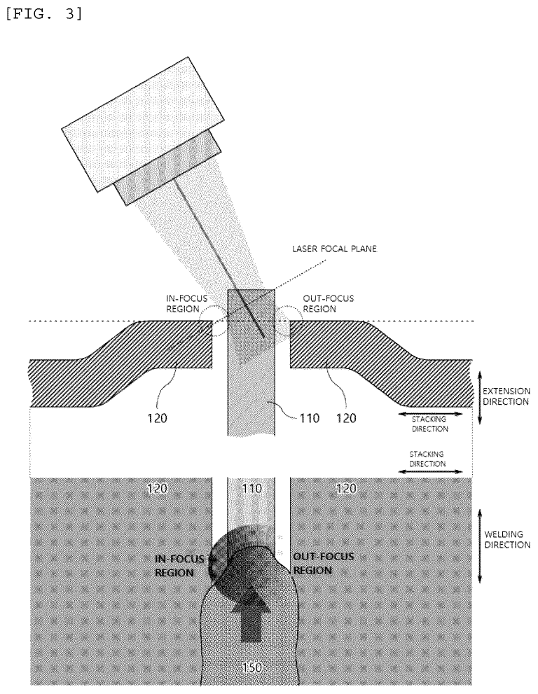

In the welding coupling step, a coupled portion between the electrode leads 110 and the bus bars 120 may be welded. More specifically, while the electrode leads 110 are inserted into the fitting parts of the bus bars 120 in the temporary coupling step, the temporarily coupled portion may be irradiated with a laser. Here, as described above, ideally, it is most preferable that the electrode leads 110 be irradiated with the laser perpendicularly at a central position in the stacking direction, that is, along the extension direction. In this case, melting may start from the center of an upper end of the electrode leads 110 and proceed equivalently to both left and right sides relative to a central line of the electrode leads 110 in the stacking direction. However, in an actual production site, it is practical to assume that the temporarily coupled portion is irradiated with the laser in a tilted manner, as illustrated in FIG. 2 or 3, because the laser is not exactly disposed perpendicularly in many cases. That is, the temporarily coupled portion is irradiated with the laser in a direction inclined with respect to the extension direction or the stacking direction, based on the central position of the electrode leads 110 in the stacking direction.

Here, when the electrode leads 110 is irradiated in a straight line along the welding direction with the laser, the electrode leads 110 may be sufficiently melted. However, the bus bars 120 may not be sufficiently melted, thereby lowering rigidity of a welded portion. Therefore, as also illustrated in FIG. 2 or 3, the laser irradiation path may be formed on the electrode leads 110 in a periodic function pattern having a predetermined amplitude and a predetermined period with respect to the central line of the electrode lead in the stacking direction. In FIG. 2, the laser irradiation path is illustrated as being formed in a zigzag pattern, and the present disclosure is not limited thereto. That is, as long as the periodic function pattern is a type capable of sufficiently melting both the electrode leads 110 and the bus bars 120, any pattern such as a zigzag pattern, a wave function pattern, or a complex curved pattern may be employed.

As described above with reference to FIGS. 1 to 4, the laser irradiation direction is inclined as illustrated in FIGS. 2 and 3, thus causing an imbalance in terms of shape and material properties between the left and right sides relative to the central line of the electrode lead 110 in the stacking direction. That is, as the laser irradiation direction is inclined, one side (the left or right side) relative to the central line of the electrode lead 110 in the stacking direction may correspond to an in-focus region, and the other side may correspond to an out-focus region. In the out-focus region, the members may not be sufficiently melted as designed, thereby causing a difference in a weld bead width between the left and right sides (i.e., a left-right imbalance in terms of shape), a difference in an amount of IMC (i.e., a left-right imbalance in terms of physical properties), or the like.

In the present disclosure, in order to resolve such an issue, a laser heat input in the in-focus region and a laser heat input in the out-focus region may be adjusted to be equivalent. More specifically, a laser irradiation intensity may be varied or a laser irradiation path pattern in which a laser irradiation path density is varied may be formed in order to make the laser heat input in the in-focus and out-focus regions equivalent. Hereinafter, the description specifically describes a case in which the laser irradiation intensity is varied as a first embodiment and a case in which the laser irradiation path pattern in which the laser irradiation path density is varied is formed as a second embodiment, respectively.

### [2] First Embodiment: Laser Irradiation Intensity Variation

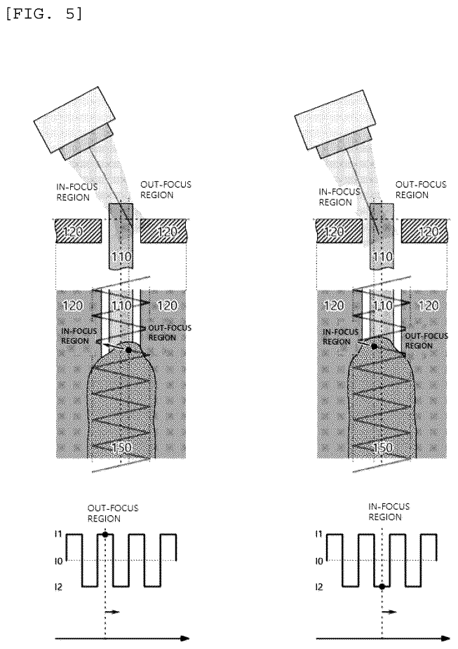

When the laser irradiation intensity is varied, the laser irradiation intensity may be varied to allow the laser irradiation intensity at the laser irradiation position in the out-focus region to be greater than the laser irradiation intensity at the laser irradiation position in the in-focus region. In particular, such a variation in the laser irradiation intensity may be directly related to the left-right variation of laser irradiation path. FIG. 5 is a diagram illustrating a laser irradiation intensity variation pattern according to the present disclosure. A principle for resolving the left-right imbalance based on the laser irradiation intensity variation according to the present disclosure is specifically described with reference to FIG. 5. In an example in FIG. 5, where the laser is tilted to the left side, the left side (where the laser is disposed) may become the in-focus region, and the right side may become the out-focus region.

A viewpoint in a left part of FIG. 5 corresponds to a state where the laser irradiation position is located on the right side relative to the central line of the electrode lead 110 in the stacking direction (while the laser follows a path of a zigzag pattern). At this point, a right-end portion of the electrode lead 110 and a right-side portion of the bus bar 120 may be required to be melted and joined to each other. In a conventional case, due to the tilting of the laser, these portions correspond to the out-focus region, and may thus receive insufficient heat input, thereby also failing to achieve sufficient melting. However, according to the present disclosure, as illustrated in a graph at the bottom of the left part of FIG. 5, the laser irradiation intensity itself may be increased to a value of I1 at this point. That is, if an original laser irradiation intensity corresponds to I0, the laser irradiation may be adjusted to an intensity of I1, which is greater than I0. Although, due to an out-of-focus condition caused by the tilting of the laser, the heat input corresponding to I1 may not be fully applied to the corresponding region, the heat input may be increased in proportion because I1 itself is greater than I0. A degree of reduction in the heat input due to the out-of-focus condition caused by the tilting of the laser when the laser irradiation is performed at a predetermined laser irradiation intensity may be theoretically obtained by using factors such as the laser irradiation intensity, the laser irradiation direction, and the laser irradiation position. Accordingly, under the same conditions of the irradiation direction and the irradiation position, the irradiation intensity capable of compensating for the insufficient heat input when the irradiation is performed at the intensity of I0 may be theoretically obtained, and the value of I1 may be previously calculated and determined in this manner.

Regarding a viewpoint in a right part of FIG. 5, a viewpoint corresponds to a state where the laser irradiation position is located on the left side relative to the central line of the electrode lead 110 in the stacking direction (while the laser follows the path of a zigzag pattern). At this point, a left-end portion of the electrode lead 110 and a left-side portion of the bus bar 120 are required to be melted and joined to each other. In this case, opposite to the case in the left part of FIG. 5, the corresponding portion corresponds to the in-focus region, and the heat input may thus instead be excessively applied to the corresponding portion. Therefore, opposite to the case in the left part of FIG. 5, an excessive degree of the heat input may be compensated for by adjusting the laser irradiation to an irradiation intensity of I2, which is smaller than I0.

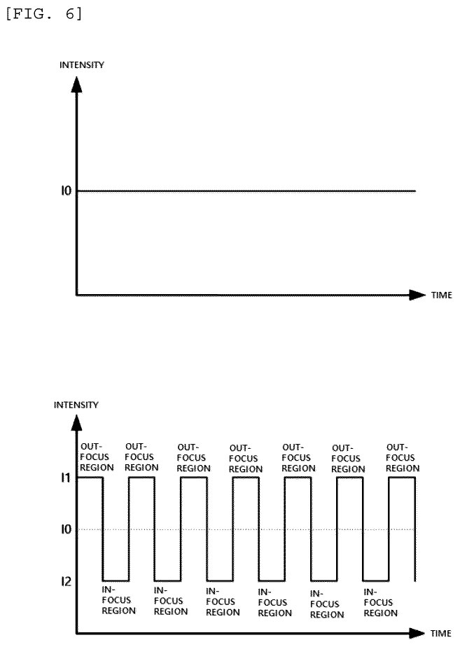

FIG. 6 illustrates a comparison between a laser irradiation intensity according to a prior art and the laser irradiation intensity according to the present disclosure. As illustrated in an upper part of FIG. 6, the laser irradiation intensity according to the prior art is always set to have a constant value of I0. Accordingly, while the laser irradiation position varies along the laser irradiation path, insufficiency or excess in the heat input may occur due to the tilting of the laser depending on the irradiation position. That is, although the heat input provided from the laser itself is set to be constant, the heat input actually reaching and applied to the members may become insufficient or excessive depending on the irradiation position. However, as illustrated in the lower diagram of FIG. 6, the laser irradiation intensity itself according to the present disclosure may be varied based on the laser irradiation intensity, the irradiation direction, and the irradiation position to compensate for the insufficiency or the excess when the predetermined irradiation intensity is applied to the members.

In consideration of such matters, it may be understood that the laser irradiation intensity is formed to have a periodic function pattern having the same period as the laser irradiation path to correspond to a variation in the laser irradiation position along the laser irradiation path. As a specific example, as illustrated in FIGS. 5 and 6, the laser irradiation path may be formed to have a zigzag pattern, and the laser irradiation intensity may be formed to have a pulse pattern in which the laser irradiation intensity is set to have a first constant value when the laser irradiation position is in the in-focus region and a second constant value when the laser irradiation position is in the out-focus region, the first constant value being smaller than the second constant value. The present disclosure is not limited thereto, and although not illustrated in the drawings, as another example, the laser irradiation path may be formed to have a wave function pattern, and the laser irradiation intensity may be formed to have a wave function pattern in which a maximum value of the laser irradiation intensity when the laser irradiation position is in the in-focus region is set to have a first constant value and a minimum value of the laser irradiation intensity when the laser irradiation position is in the out-focus region is set to have a second constant value, the first constant value being smaller than the second constant value.

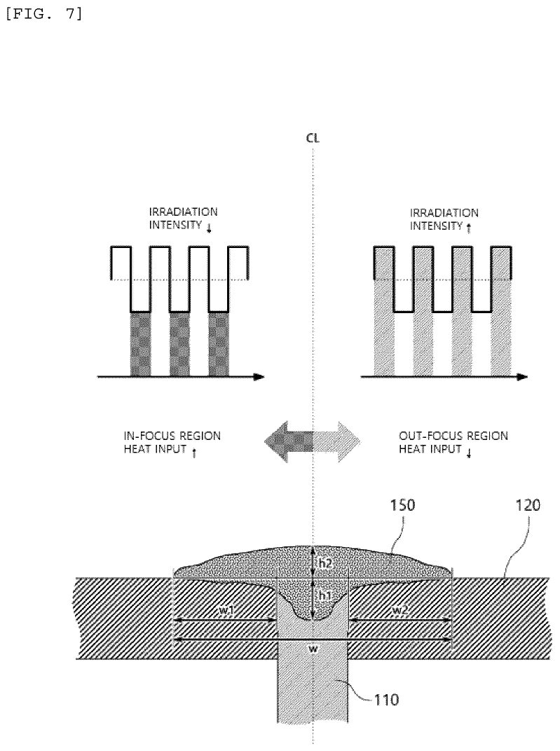

As briefly described above, the laser irradiation intensity variation according to the present disclosure is for ultimately manufacturing the laser heat input in the in-focus region and the laser heat input in the out-focus region a equivalent value. FIG. 7 is a diagram illustrating the principle for resolving the left-right imbalance based on the laser irradiation intensity variation according to the present disclosure. As described above, the heat input may be higher in the in-focus region and lower in the out-focus region due to the tilting of the laser when the laser irradiation intensity is the same. In this case, when the laser irradiation intensity is made lower in the in-focus region and higher in the out-focus region, the excess or insufficiency caused by the tilting of the laser may be compensated for by the laser irradiation intensity, thus manufacturing the laser heat input actually reaching and applied to the members the equivalent value on both the left and right sides.

In general, in the secondary battery module, the electrode lead 110 may include an aluminum material, and the bus bar 120 may include a copper material. In consideration of physical properties of these materials and general specifications or the like of the electrode lead 110 and the bus bar 120, a laser heat input value may be set to be within a range of 30 J/mm² to 43 J/mm² based on a state where the laser irradiation reaches the members.

### [3] Second Embodiment: Laser Irradiation Path Density Variation

If the laser irradiation path density is varied, the laser irradiation path pattern may be formed to have the laser irradiation path density varied to allow at the laser irradiation position in the out-focus region to be greater than the laser irradiation path density at the laser irradiation position in the in-focus region. That is, although the laser irradiation path in the in-focus region and the laser irradiation path in the out-focus region may be formed to be different in shape, the laser irradiation path pattern may ultimately make the laser heat input in the in-focus region and the laser heat input in the out-focus region have the equivalent value, based on a difference in the laser irradiation path density.

To describe in a simplified manner, the following may be stated. In the in-focus region, laser energy may be transmitted to the member without loss, and the member may thus be sufficiently melted and mixed, thereby implementing the intended shape and material properties. On the other hand, in the out-focus region, a considerable loss may occur due to the out-of-focus condition when the laser energy is transmitted to the member. Therefore, the member may not be sufficiently melted as intended, thereby reducing the rigidity of the welded portion. This description is provided under an assumption that time intervals at which the laser irradiation is performed to the in-focus region and the out-focus region are the same.

Here, the laser heat input in the in-focus region and the laser heat input in the out-focus region may be made equivalent if a laser irradiation time is made shorter in the in-focus region as much as the laser irradiation intensity is sufficiently high, and conversely, if the irradiation time is made longer in the out-focus region as much as the laser irradiation intensity is lowered due to the out-of-focus condition. The present disclosure is directed to this perspective, that is, to allow the laser to relatively stay longer in the out-focus region. From a viewpoint of the laser irradiation path, the laser staying longer in the out-focus region refers to a situation in which the laser irradiation path is formed more densely in the out-focus region. That is, this description means that a laser irradiation path density at the laser irradiation position in the out-focus region is made greater than a laser irradiation path density at the laser irradiation position in the in-focus region.

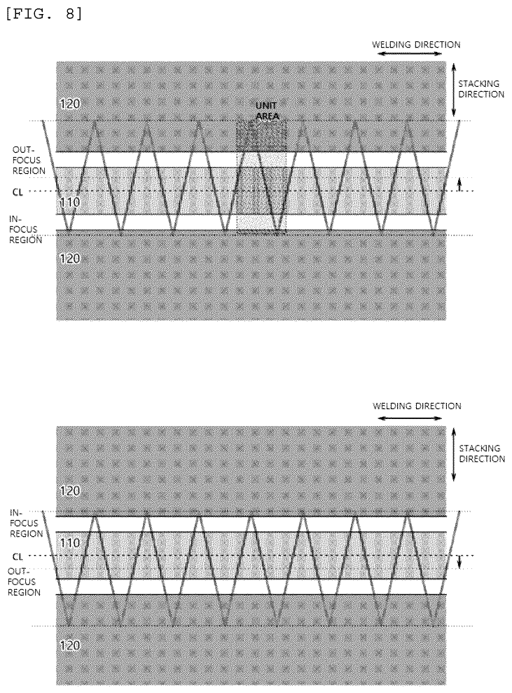

A laser irradiation path pattern for manufacturing the laser irradiation path more densely formed in the out-focus region may be variously and freely modified and implemented. However, if the irradiation path excessively deviates from an existing laser irradiation path, difficulties may occur when changing control of the laser irradiation apparatus. Therefore, it is preferable that the pattern be consistent with the spirit of the present disclosure and also be easily implemented by using even a laser irradiation apparatus according to the prior art. Hereinafter, examples of such laser irradiation path patterns are described with reference to FIGS. 8 to 10 in Embodiments 2-1, 2-2, and 2-3.

FIG. 8 illustrates the laser irradiation path pattern according to Embodiment 2-1 of the present disclosure. In Embodiment 2-1, the laser irradiation path is basically formed in a zigzag pattern. As illustrated in the example in FIG. 2 and disclosed in the above-described prior documents or the like, a zigzag pattern is a pattern generally widely used in laser welding. However, in the prior art, a central line of a zigzag pattern may be commonly disposed to overlap a central line of the joining portion. In contrast, as illustrated in FIG. 8, in the present disclosure, a central line of a zigzag pattern may be biased to the out-focus region, thus manufacturing the pattern different from the prior in this respect.

An upper part of FIG. 8 illustrates a case where the out-focus region is formed at an upper side and the in-focus region is formed at a lower side as a laser light source is biased downward based on the central line of the electrode lead 110 in stacking direction (indicated by “CL” in the drawing). In this case, as illustrated in the drawing, the central line of a zigzag pattern may be biased to the out-focus region, that is, disposed upward. When the upper side and the lower side are divided relative to the central line (CL) of the electrode lead 110 in the stacking direction within a unit area, a total length of the laser irradiation path included in an upper portion of the unit area may be greater than a total length of the laser irradiation path included in a lower portion of the unit area. That is, the laser irradiation path density may be greater in the upper portion (i.e., the out-focus region) of the unit area.

A lower part of FIG. 8 illustrates a case where the out-focus region is formed at the lower side and the in-focus region is formed at the upper side as the laser light source is biased upward based on the central line of the electrode lead 110 in the stacking direction. This configuration is the same as that illustrated in the upper part of FIG. 8 except that the upper and lower sides are symmetrically reversed. Accordingly, it is to be understood to be in the same context as the case illustrated in the upper part of FIG. 8, thus omitting any further description.

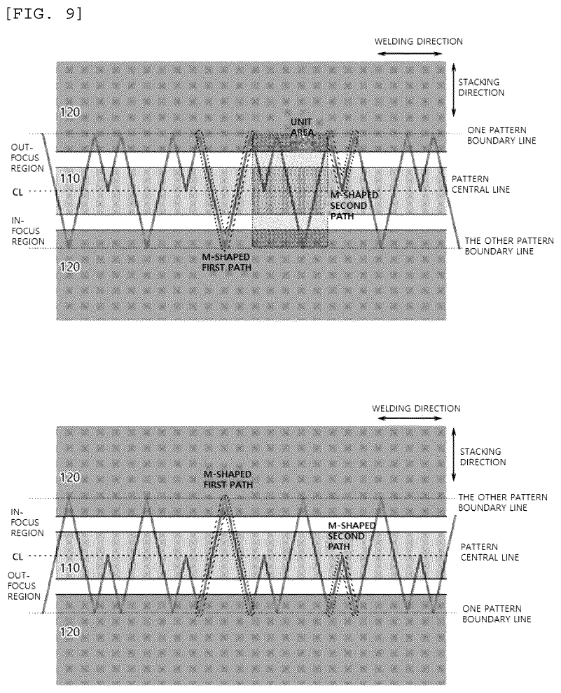

FIG. 9 illustrates the laser irradiation path pattern according to Embodiment 2-2 of the present disclosure. In Embodiment 2-2, the laser irradiation path is formed in an M-shaped pattern. The M-shaped pattern may be clearly defined as follows. The M-shaped pattern may be a pattern formed within a range of a pair of pattern boundary lines extending in parallel to each other, under an assumption that a pattern central line extends in parallel to the pair of pattern boundary lines at a central position of the pair of pattern boundary lines. Here, the M-shaped pattern may include two types of paths, i.e., an M-shaped first path and an M-shaped second path. The M-shaped first path may proceed in a straight line in the order of one pattern boundary line, the other pattern boundary line, and one pattern boundary line. In addition, the M-shaped second path may proceed in a straight line in the order of one pattern boundary line, the pattern central line, and one pattern boundary line. Here, the M-shaped pattern may be a pattern in which the M-shaped first path and the M-shaped second path are alternately disposed. As described above, the laser irradiation path in Embodiment 2-2 may be formed in the M-shaped pattern, and the M-shaped second path may be disposed in the out-focus region, and the pattern central line may be disposed to coincide with the central line of the electrode lead in the stacking direction.

An upper part of FIG. 9 illustrates a case where the out-focus region is formed at an upper side and the in-focus region is formed at a lower side as the laser light source is biased downward based on the central line of the electrode lead 110 in the stacking direction (indicated by “CL” in the drawing). In this case, the laser irradiation path pattern may be formed to have the M-shaped first path disposed in each of the out-focus region and the in-focus region, and the M-shaped second path further additionally disposed in the out-focus region. When the upper side (in this case, coinciding with the out-focus region) and the lower side (in this case, coinciding with the in-focus region) are divided relative to the central line (CL) of the electrode lead 110 in the stacking direction within the unit area, a total length of the laser irradiation path included in the upper portion of the unit area may be greater than a total length of the laser irradiation path included in the lower portion of the unit area (as in Embodiment 2-1). That is, the laser irradiation path density may be greater in the upper portion (i.e., the out-focus region) of the unit area.

A lower part of FIG. 9 illustrates a case where the out-focus region is formed at the lower side and the in-focus region is formed at the upper side as the laser light source is biased upward based on the central line of the electrode lead 110 in the stacking direction. This configuration is the same as that illustrated in the upper part of FIG. 9 except that the upper and lower sides are symmetrically reversed (as in Embodiment 2-1). Accordingly, it is to be understood to be in the same context as the case illustrated in the upper part of FIG. 9, thus omitting any further description. In addition, from a shape viewpoint, the upper part of FIG. 9 may be considered to draw an approximate “M”, and the lower part of FIG. 9 may be considered to draw an approximate “W.” In this regard, the upper part of FIG. 9 may be referred to as the M-shaped pattern and the lower part of FIG. 9 may be referred to as a W-shaped pattern separately. However, as described above, it is also acceptable to commonly refer to these patterns by a single term.

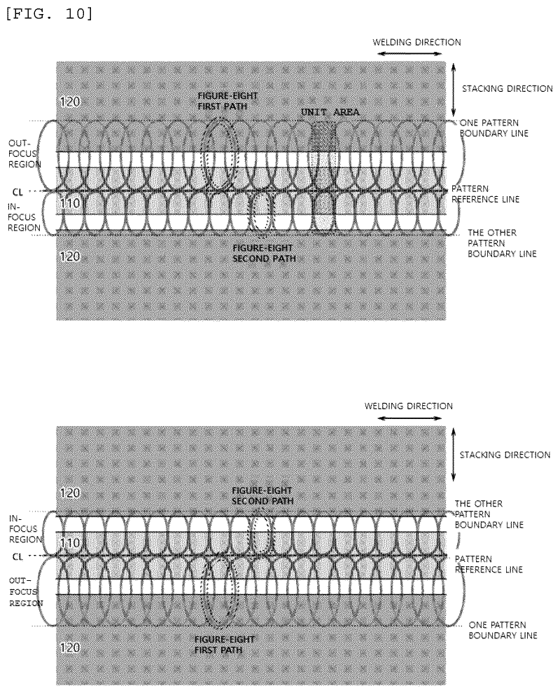

FIG. 10 illustrates the laser irradiation path pattern according to Embodiment 2-3 of the present disclosure. In Embodiment 2-3, the laser irradiation path is formed in a figure-8 pattern. The figure-8 pattern is clearly defined as follows. The figure-8 pattern may be a pattern formed within a range of a pair of pattern boundary lines extending in parallel to each other, under an assumption that a pattern reference line extends in parallel to the pair of pattern boundary lines at an arbitrary position within the range of the pair of pattern boundary lines. Here, the figure-8 pattern may include two types of paths, i.e., a figure-8 first path and a figure-8 second path. The figure-8 first path may proceed in an elliptical shape in the order of the pattern reference line, one pattern boundary line, and the pattern reference line. In addition, the figure-8 second path may proceed in an elliptical shape in the order of the pattern reference line, the other pattern boundary line, and the pattern reference line. In this case, the figure-8 pattern may be a pattern in which the figure-8 first path and the figure-8 second path are alternately disposed. Here, the two types of paths included in the figure-8 pattern may draw ellipses of the same size, or may be biased to have one side drawn larger. In this case, it is assumed that the pattern reference line is biased to the other side. Accordingly, a major axis of the ellipse formed by the figure-8 first path may be greater than a major axis of the ellipse formed by the figure-8 second path. The laser irradiation path in Embodiment 2-3 may be formed in the figure-8 pattern as described above. Here, the figure-8 first path may be disposed in the out-focus region, and the pattern reference line may be disposed to coincide with the central line of the electrode lead in the stacking direction.

An upper part of FIG. 10 illustrates a case where the out-focus region is formed at an upper side and the in-focus region is formed at a lower side as the laser light source is biased downward based on the central line of the electrode lead 110 in the stacking direction (indicated by “CL” in the drawing). The figure-8 first path may be disposed in the out-focus region. Here, a minor axis width of an elliptical shape formed by the figure-8 first path may be greater than a width of the unit area, and the figure-8 first paths may thus overlap one or more times within the unit area. Meanwhile, the figure-8 second path may be disposed in the in-focus region. Here, a minor axis width of an ellipse formed by the figure-8 second path may be smaller than the minor axis width of the ellipse formed by the figure-8 first path, as illustrated in the drawing, and the figure-8 second paths may thus overlap less than the figure-8 first paths (e.g., almost not overlapping as illustrated in the embodiment in FIG. 10). When the upper side and the lower side are divided relative to the central line (CL) of the electrode lead 110 in the stacking direction within the unit area, a total length of the laser irradiation path included in an upper portion of the unit area may be greater than a total length of the laser irradiation path included in a lower portion of the unit area (as in the first and second embodiments). That is, the laser irradiation path density may be greater in the upper portion (i.e., the out-focus region) of the unit area.

A lower part of FIG. 10 illustrates a case where the out-focus region is formed at a lower side and the in-focus region is formed at an upper side as the laser light source is biased upward based on the central line of the electrode lead 110 in the stacking direction. This configuration is the same as that illustrated in the upper part of FIG. 10 (as in the first and second embodiments) except that the upper and lower sides are symmetrically reversed. Accordingly, it is to be understood to be in the same context as the case illustrated in the upper part of FIG. 10, thus omitting any further description.

As briefly described above, varying the laser irradiation path density for ultimately manufacturing the laser heat input in the in-focus region and the laser heat input in the out-focus region the equivalent value. As confirmed from all the embodiments in FIGS. 8 to 10, when viewed within the unit area, the total length of the laser irradiation path in the out-focus region may be greater than the total length of the laser irradiation path in the in-focus region. That is, even if, in the out-focus region, the laser irradiation intensity is lowered from a designed value due to the out-of-focus condition and the energy itself reaching the member is reduced, the insufficiency of the heat input may be compensated for by irradiating the temporarily coupled portion with the laser longer (i.e., by having a longer irradiation path). The opposite is true for the in-focus region. Accordingly, the compensation may be achieved by irradiating the temporarily coupled portion with the laser at a relatively high irradiation intensity and only for a shorter path, thereby compensating for the excess of the heat input. As a result, the excess or the insufficiency caused by the tilting of the laser may be compensated for by the difference in the laser irradiation path density, and the laser heat input actually reaching and applied to the member may thus ultimately be the equivalent value on both the left and right sides.

As in the first embodiment, in general, in the secondary battery module, the electrode lead 110 may include an aluminum material and the bus bar 120 may include a copper material. In consideration of the physical properties of these materials and the general specifications or the like of the electrode lead 110 and the bus bar 120, the laser heat input value may be set to be in the range of 30 J/mm² to 43 J/mm² based on the state where the laser irradiation reaches the members.

### [4] Shape of the Weld Bead According to the Present Disclosure

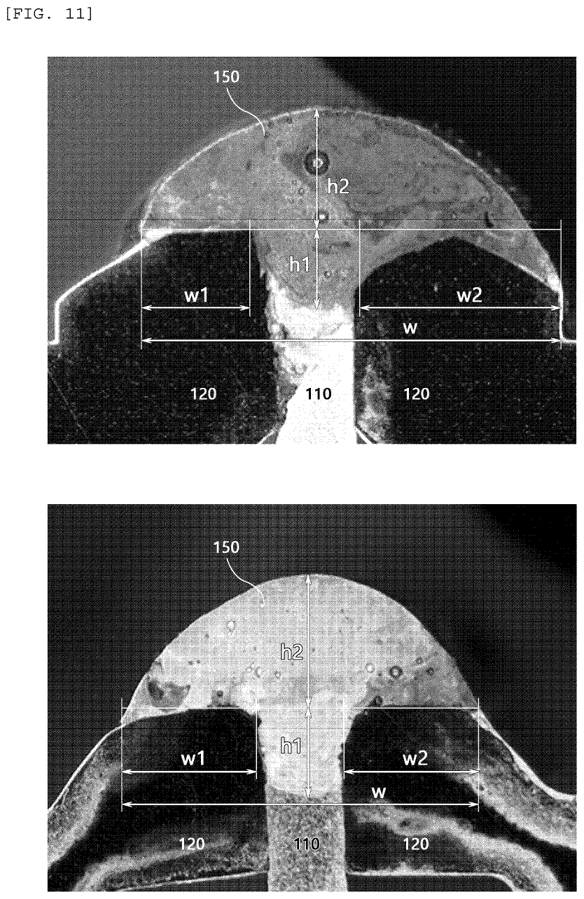

As described above, the manufacturing method according to the present disclosure is for resolving the left-right imbalance occurring in the weld bead 150 formed during laser welding between the electrode lead 110 and the bus bar 120. That is, the weld bead 150 manufactured by the manufacturing method according to the present disclosure may be equivalent on the left and right sides. FIG. 11 illustrates a comparison between a weld bead shape according to the prior art and the weld bead shape according to the present disclosure. In order to more specifically describe a difference between the prior art and the present disclosure, terms designating respective parts are defined as illustrated in FIG. 11 as follows.

When the direction in which the battery cells 100 are stacked is referred to as the stacking direction, and the left and right sides are determined based on the central line of the electrode lead 110 in the stacking direction, w1 refers to a distance from a left outer surface of the electrode lead 110 to a left end of the weld bead 150, and w2 refers to a distance from a right outer surface of the electrode lead 110 to a right end of the weld bead 150. For reference, h1 refers to a distance from an upper-surface central position of the bus bar 120 to a lower end of the weld bead 150, and h2 refers to a distance from the upper-surface central position of the bus bar 120 to an upper end of the weld bead 150. Here, the weld bead 150 may have a shape satisfying the following expression:

$$\vert w 1 - w 2 \vert < 0.1 mm$$

In particular, the weld bead 150 formed by the manufacturing method according to the present disclosure exhibits a greater effect of resolving the left-right imbalance when the weld bead 150 is formed to be elongated to left and right sides. When the electrode lead 110 itself has a very small thickness, the left-right imbalance as described above may not occur significantly, and in such a case, it may not be necessary to apply a complicated control for varying the laser irradiation intensity or forming a complicated laser irradiation path. However, when the electrode lead 110 itself has a significant thickness, it is apparent that left-right the imbalance may occur significantly, and in such a case, it is highly advantageous to apply the manufacturing method according to the present disclosure. In consideration of such a point, it is preferable that the manufacturing method according to the present disclosure be applied when the weld bead 150 has a shape sufficiently elongated to the left and right sides. In this regard, the weld bead 150 may have a shape satisfying the following expressions:

$$0.5 mm < w 1 < 0.8 mm , and 0.5 mm < w 2 < 0.8 mm .$$

Although the above-described relations are described as absolute values in millimeters, more broadly, the [sufficiently elongated shape of the weld bead 150 in the left and right sides] may be defined as relative values. Referring to FIG. 11 and the definitions of w, w1, and w2 described above, a thickness of the electrode lead 110 may be calculated as w−w1−w2. Here, a condition that the left length w1 or right length w2 of the weld bead 150 is sufficiently greater than the thickness of the electrode lead 110 may be expressed as follows. That is, the weld bead 150 may have a shape satisfying the following expressions:

$$120 \% < w 1 / ( w - w 1 - w 2 ) < 200 \% , and 120 \% < w 2 / ( w - w 1 - w 2 ) < 200 \% .$$

Referring back to FIG. 11, the upper part of FIG. 11 illustrates the weld bead according to the prior art, and the lower part of FIG. 11 illustrates the weld bead according to the present disclosure. As explicitly illustrated in FIG. 11, in the prior art, w2 is considerably greater than w1, and thus an obvious left-right imbalance shape is confirmed. However, in the present disclosure, w1 and w2 are formed to be nearly identical values, and it is thus confirmed that the greatly excellent left-right balance is implemented.

As described above, in general, in the secondary battery module, the electrode lead 110 may include an aluminum material and the bus bar 120 may include a copper material. The weld bead 150 manufactured by the manufacturing method according to the present disclosure may have a copper weight ratio value in a range of 5 wt % to 50 wt %.

As set forth above, according to the present disclosure, the laser having a relatively higher irradiation intensity or a higher laser irradiation path density may be applied to the region where the relatively smaller heat input is formed under the laser irradiation of the same intensity, that is, the region irradiated while the laser focus is not matched, thereby ultimately forming the equivalent left-right heat input during the laser irradiation to resolve the left-right imbalance occurring in the welded portion caused by the inclined laser irradiation direction during the laser welding.

As described above, according to the present disclosure, even though the welded portion is irradiated in the tilted manner with the laser, the left-right heat input may become equivalent, thus also allowing the finally-formed weld bead to be equivalently formed in terms of both shape and physical properties. Accordingly, the issues such as durability degradation, which conventionally occur because the weld bead is formed to have the left-right imbalance in terms of shape and material properties due to the tilted laser irradiation, may be completely eliminated.

The present disclosure is not limited to the above-described embodiments, may be variously applied, and may be variously modified by those skilled in the art to which the present disclosure pertains without departing from the gist of the present disclosure claimed in the appended claims.

1. A method for manufacturing a battery module, which includes a plurality of battery cells stacked on each other and each including electrode leads, a bus bar including a plurality of fitting parts into which the electrode leads protruding from the battery cells are inserted, and a weld bead formed by laser welding to couple the electrode leads to the bus bars,
wherein when a direction in which the electrode lead protrudes and extends from the battery cell is referred to as an extension direction, a direction in which the battery cells are stacked is referred to as a stacking direction, and a direction perpendicular to the extension direction or the stacking direction and in which welding is performed is referred to as a welding direction,
the method comprising:
a temporary coupling step of temporarily coupling the electrode lead to the fitting part by being inserted therein; and
a welding coupling step of welding and coupling a coupled portion between the electrode lead and the bus bar by irradiating the temporarily coupled portion with a laser in a direction inclined with respect to the extension direction or the stacking direction, based on a central position of the electrode lead in the stacking direction, while forming a laser irradiation path in a periodic function pattern having a predetermined amplitude and predetermined period with respect to a central line of the electrode lead in the stacking direction,
wherein a laser heat input in the in-focus region and a laser heat input in the out-focus region are adjusted to be equivalent when one of left and right sides relative to the central line of the electrode lead in the stacking direction corresponds to an in-focus region and the other corresponds to an out-focus region as the laser irradiation direction is inclined.

2. The method of claim 1, wherein a laser irradiation intensity is varied or a laser irradiation path density is varied in order to make the laser heat input in the in-focus region is equivalent to the laser heat input in the out-focus region,
when the laser irradiation intensity is varied, the laser irradiation intensity is varied to allow the laser irradiation intensity at a laser irradiation position in the out-focus region to be greater than the laser irradiation intensity at a laser irradiation position in the in-focus region, and
when the laser irradiation path density is varied, the laser irradiation path pattern is formed to have the laser irradiation path density varied to allow the laser irradiation path density at the laser irradiation position in the out-focus region to be greater than the laser irradiation path density at the laser irradiation position in the in-focus region.

3. The method of claim 2, wherein the laser irradiation intensity is varied to make the laser heat input in the in-focus region and the laser heat input in the out-focus region equivalent,
the laser irradiation intensity being formed to have the periodic function pattern having the same period as the laser irradiation path to correspond to a variation in the laser irradiation position along the laser irradiation path.

4. The method of claim 3, wherein the laser irradiation path is formed to have a pattern, and
the laser irradiation intensity is formed to have a pulse pattern in which the laser irradiation intensity is set to have a first constant value when the laser irradiation position is in the in-focus region and a second constant value when the laser irradiation position is in the out-focus region,
the first constant value being smaller than the second constant value.

5. The method of claim 3, wherein the laser irradiation path is formed to have a wave function pattern, and
the laser irradiation intensity is formed to have the wave function pattern in which a maximum value of the laser irradiation intensity in the in-focus region is set to have a first constant value, and a minimum value of the laser irradiation intensity in the out-focus region is set to have a second constant value,
the first constant value being smaller than the second constant value.

6. The method of claim 2, wherein the laser irradiation path density is varied to make the laser heat input in the in-focus region and the laser heat input in the out-focus region equivalent, and
the laser irradiation path is formed in a pattern in which a pattern central line is biased to the out-focus region.

7. The method of claim 2, wherein the laser irradiation path density is varied to make the laser heat input in the in-focus region and the laser heat input in the out-focus region equivalent, and
the laser irradiation path is formed in an M-shaped pattern if the M-shaped pattern is defined as a pattern formed within a range of a pair of pattern boundary lines extending parallel to each other, and including an M-shaped first path and an M-shaped second path, which are alternately disposed, when a pattern central line extends in parallel to the pair of pattern boundary lines at a central position of the pair of pattern boundary lines,
the M-shaped first path proceeding in a straight line in an order of one pattern boundary line, the other pattern boundary line, and the one pattern boundary line, the M-shaped second path proceeding in a straight line in an order of the one pattern boundary line, the pattern central line, and the one pattern boundary line,
the M-shaped second path being disposed in the out-focus region, and the pattern central line being disposed to coincide with the central line of the electrode lead in the stacking direction.

8. The method of claim 2, wherein the laser irradiation path density is varied to make the laser heat input in the in-focus region and the laser heat input in the out-focus region equivalent, and
the laser irradiation path is formed in a figure-8 pattern,
the figure-8 pattern being a pattern including a figure-8 first path and a figure-8 second path, which are alternately disposed, as a pattern formed within a range of a pair of pattern boundary lines extending in parallel to each other when a pattern reference line at an arbitrary position within the range of the pair of pattern boundary lines extends in parallel to the pair of pattern boundary lines,
the figure-8 first path proceeding in an elliptical shape in an order of the pattern reference line, one pattern boundary line, and the pattern reference line, the figure-8 second path proceeding in an elliptical shape in an order of the pattern reference line, the other pattern boundary line, and the pattern reference line, and
the figure-8 first path being disposed in the out-focus region, and the pattern reference line being disposed to coincide with the central line of the electrode lead in the stacking direction when the pattern reference line is biased to the other side to have a major axis of an ellipse formed by the figure-8 first path is greater than a major axis of an ellipse formed by the figure-8 second path.

9. The method of claim 1, wherein a laser heat input value is in a range of 30 J/mm² to 43 J/mm².

10. A battery module comprising:
a plurality of battery cells stacked on each other and each including electrode leads;
a bus bar including a plurality of fitting parts into which the electrode leads protruding from the battery cells are inserted; and
a weld bead formed by laser welding to couple the electrode leads to the bus bars,
wherein, when a direction in which the battery cells are stacked is referred to as a stacking direction, and left and right sides are determined based on a central line of the electrode lead in the stacking direction, the weld bead has a shape satisfying the following expression:
$$\vert w 1 - w 2 \vert < 0.1 mm$$
where w1 refers to a distance from a left outer surface of the electrode lead to a left end of the weld bead, and w2 refers to a distance from a right outer surface of the electrode lead to a right end of the weld bead.

11. The battery module of claim 10, wherein the weld bead has a shape satisfying the following expressions:
$$0.5 mm < w 1 < 0.8 mm , and 0.5 mm < w 2 < 0.8 mm .$$

12. The battery module of claim 11, wherein the weld bead has a shape satisfying the following expressions:
$$120 \% < w 1 / ( w - w 1 - w 2 ) < 200 \% , and 120 \% < w 2 / ( w - w 1 - w 2 ) < 200 \%$$
where w refers to a distance from the left end of the weld bead to the right end of the weld bead.

13. The battery module of claim 10, wherein the electrode lead includes an aluminum material, and the bus bar includes a copper material.

14. The battery module of claim 10, wherein the weld bead has a copper weight ratio value in a range of 5 wt % to 50 wt %.
